(19) United States
(12) Patent Application Publication
(10) Pub. No.: US 2020/0109053 A1
(43) Pub. Date: Apr. 9, 2020

(54) PHOSPHORIC ACID PRODUCTION METHODS AND COMPOSITIONS

(71) Applicant: CYTEC INDUSTRIES INC., Princeton, NJ (US)

(72) Inventors: Xueping Qiu, Stamford, CT (US); Lei Zhang, Stamford, CT (US)

(73) Assignee: CYTEC INDUSTRIES INC., Princeton, NJ (US)

(21) Appl. No.: 16/590,885

(22) Filed: Oct. 2, 2019

Related U.S. Application Data
(60) Provisional application No. 62/741,741, filed on Oct. 5, 2018.

(51) Int. Cl. C01B 25/232; B01D 19/04

(52) U.S. Cl. CPC C01B 25/232; B01D 19/0422

(57) ABSTRACT

A wet process phosphoric acid production method comprises digesting phosphate-containing ore in a slurry comprising sulfuric acid, whereby phosphoric acid and calcium sulfate crystals are formed; and separating the phosphoric acid from the calcium sulfate crystals; wherein a defoamer and a poly(carboxylic acid), or salt thereof, having a weight-average molecular weight of less than 1,000,000 grams per mole (g/mol), are added to the slurry. The poly(carboxylic acid) can be a poly(acrylic acid), or salt thereof, and the defoamer can be a dialkyl sulfosuccinate salt and an aliphatic alcohol or a fatty acid ester. The method enhances separation of phosphoric acid from calcium sulfate crystals in wet process phosphoric acid production by any one of increasing the volume average particle size of the calcium sulfate crystals, increasing filtration rate, and reducing foam formation.

### CROSS-REFERENCE TO RELATED APPLICATIONS

This application claims priority to U.S. Provisional Application No. 62/741,741, filed Oct. 5, 2018, the entire content of which is incorporated herein by reference.

### BACKGROUND OF THE INVENTION

About 90% of the world's phosphoric acid is produced according to the wet process, which involves acidulating phosphate ore, which contains calcium phosphate, with sulfuric acid to yield crude wet-process phosphoric acid (WPA) and insoluble calcium sulfate (gypsum, or phosphogypsum). An overview of the manufacture of phosphoric acid and phosphates and is provided by Becker in “Phosphates and Phosphoric Acids”, Marcel Dekker, Inc., 1989; and by Stack in “Phosphoric Acid, Part 1 and Part 2”, Marcel Dekker, Inc., 1968. In the wet process, phosphate ores are cleaned in a wash plant, ground in a ball mill, and fed into a series of reactors for digestion with sulfuric acid along with recycled phosphoric acid from the process. After digestion, the reaction slurry is filtered to separate phosphoric acid from undissolved ores, the newly formed gypsum, and the gangues. The filtered, crude WPA is then sent to clarifiers and evaporators for further purification and concentration. The purified phosphoric acid is either sent out as merchant grade acid (MGA) or further concentrated to make 69% P₂O₅ super phosphoric acid (SPA). SPA can be converted to many end products including chemical reagents, rust inhibitors, food additives, dental and orthopaedic etchants, electrolytes, fluxes, dispersing agents, industrial etchants, fertilizer feedstocks, and components of home cleaning products. For example, crude phosphoric acid is concentrated to 54% (P₂O₅ basis) before use in monoammonium phosphate (MAP), diammonium phosphate (DAP), or ammonium phosphate-sulfate (APS) production.

Efficient filtration of phosphoric acid from suspended solids after digestion of the ores and efficient clarification of phosphoric acid at various stages serves to maximize production rates. For a plant limited by filtration capacity, improvement of filtration efficiency can have a huge commercial impact. High molecular weight flocculants are often used to aid the filtration and clarification process. For example, as noted in U.S. Pat. No. 4,291,005 to Poulos et al. and U.S. Pat. No. 4,800,071 to Kaesler et al., conventional organic flocculants, such as polyacrylamide and acrylamide/sodium acrylate copolymers, can be used to reduce fine particulate solids (fines) content to clarify phosphoric acid and to improve filtration rate.

Another approach to improving filtration rate is to reduce the amount of fines formed during the digestion of phosphate ores. Reagents that reduce the amount of fines are called crystal growth modifiers. The effect of crystal growth modifiers can be assessed by measuring volume average particle sizes and filtration times. U.S. Pat. No. 3,192,014 describes the use of alkyl benzene sulfonic acid, isopropyl naphthalene sulfonic acid, and alkali metal salts thereof, to form gypsum crystals with improved filterability. U.S. Pat. No. 4,140,748 also discloses the use of organic sulfonic acids or derivatives, such as sodium dodecyl sulfonate, as crystal growth modifiers to improve the growth of calcium sulfate hemihydrate crystals to improve the filtration rate of phosphoric acid slurry. U.S. Pat. No. 3,796,790 discloses the use of straight chain alkyl benzene sulfonic acids, branched chain alkyl benzene sulfonic acids, straight chain alkyl benzene sulfonates, branched chain alkyl benzene sulfonates, straight chain alkyl sulfates, branched chain alkyl sulfates, and petroleum sulfonates to aid separation of phosphoric acid from gypsum.

U.S. Pat. No. 5,009,873 describes methods of increasing filtration rate of phosphoric acid product slurries using acrylamide/2-acrylamidomethylpropane sulfonic acid copolymers with a weight average molecular weight of about 1,000,000 to about 10,000,000 grams per mole (g/mol). The polymers disclosed consist of a predominant proportion of acrylamide units (60-90 mole percent (mol %)) and a minor portion of 2-acrylamidomethylpropane sulfonic acid units (10 to 40 mol %). It further teaches that “polymers having a weight average molecular weight of significantly less than 1,000,000 will not be effective crystal modifiers in the process of the present invention”. In “Enhanced Filtration of Phosphogypsum” (Florida Institute of Phosphate Research, 1995, Publication No. 01-119-133), Brij M. Moudgil discusses the use of polyacrylamide of molecular weight 10,000,000 to 20,000,000 g/mol, poly(ethylene oxide) of molecular weight 4,000,000 to 8,000,000 g/mol, and alkylated sulfonates to increase the size of phosphogypsum particles and improve filtration rate.

Several publications by H. El-Shall et al., “Effect of Surfactants on Phosphogypsum Crystallization and Filtration During Wet-process Phosphoric Acid Production”, Separation Science and Technology, 35 (2000) 395-410, “Increasing the Filtration Rate of Phosphogypsum Using Surfactant”, Hydrometallurgy, 85 (2007) 53-58, and “Effect of phosphonate additive on crystallization of gypsum in phosphoric and sulfuric acid medium”, Crystal Research and Technology, 37 (2002) 1264-1273, and by M. H. H. Mahmoud et al. “Crystal Modification of Calcium Sulfate Dihydrate in the Presence of Some Surface-active Agents”, Journal of Colloid and Interface Science, 270 (2004) 99-105, discuss the effect of a nonionic surfactant (CMR-100) containing a mixture of C₆₋₂₂ sorbitan esters, aminotris(methylenephosphonic acid), and cetyltrimethylammonium bromide, on modifying gypsum crystal growth and improving filtration of phosphoric acid.

Foam control is also desirable in WPA production, especially for the digestion step. Excessive foams generated during the digestion step, for example from carbon dioxide evolution, can take up a large volume of the digestion vessel and decrease the throughput and productivity. Excessive foams can also cause overflows of foam, imposing hazardous conditions and safety issues. As used herein, defoamers are defined as any additives that reduce or prevent foam formation, and include antifoamers. Defoamers can be oil-based, water-based, or powder-based, and include, for example, polysiloxanes (silicones), mineral oils, vegetable oils, surfactants, or other polymers. Fatty acids, fatty acid esters, aliphatic alcohols, and sulfosuccinate surfactants are commercially available and used to control foam in WPA production. U.S. Pat. No. 4,065,403 discloses a defoamer having a majority of a sulfonated tall oil and a minority of a nonionic additive for controlling foam in highly acidic media. U.S. Pat. No. 4,415,472 discloses the use of a mixture of alkali salts of succinic acid dialkyl esters and higher linear or branched aliphatic alcohols as defoaming agents for mineral acid digestion media. U.S. Pat. No. 6,544,489 discloses a defoamer formulation for high strength acid media based on ester condensates of C₁₂₋₂₀ fatty acids and ethoxylated C₁₋₄ alcohols. U.S. Patent Application Publication No. 2006/0041027 discloses compositions capable of preventing foam from forming based on mixtures of saturated or non-saturated fatty acids or derivatives and rosin acid compounds. International Publication No. WO2017/006170 discloses the use of inverse microemulsions of anionic surfactants based on alkali salts of sulfosuccinic acid dialkyl esters, fatty acids, fatty acid esters, and oxygenated solvents for foam control in a WPA production media.

While the various reagents discussed above may have some merits and applicability in WPA production, the filtration part of the process still frequently becomes a bottleneck when either the filter cloth develops fluorosilicate type scale requiring cleaning and/or the gypsum particle size and morphology do not allow for efficient filtration. Some plants have to perform physical cleaning of the scale or replace the filter cloth in less than a week. The adverse economic impact for these filtration-related issues is substantial, and the industry is in need of a more efficient filtration aid technology. Accordingly, improvement in the compositions and methods presently available for filtration of phosphoric acid in the production process is desirable. Many factors (e.g., ore type, temperature, agitation, reactor design, acid chemistry, foreign ions, organic species, and viscosity of phosphoric acid medium) can affect the performance of crystal growth modifiers. Therefore, there is an unmet need for high-efficiency crystal growth modifiers and methods for controlling crystal growth and/or enhancing filtration rate under a variety of end-use conditions. High-efficiency crystal growth modifiers and methods for controlling crystal growth and/or enhancing filtration rate would be a useful advance in the art and would find rapid acceptance in the industry.

### SUMMARY OF THE INVENTION

A wet process phosphoric acid production method includes digesting phosphate-containing ore in a slurry comprising sulfuric acid, whereby phosphoric acid and calcium sulfate crystals are formed; and separating the phosphoric acid from the calcium sulfate crystals; wherein a defoamer and a poly(carboxylic acid), or salt thereof, having a weight-average molecular weight of less than 1,000,000 grams per mole (g/mol), are added to the slurry.

A wet process phosphoric acid production method includes digesting phosphate-containing ore in a slurry comprising sulfuric acid, whereby phosphoric acid and calcium sulfate crystals are formed; and separating the phosphoric acid from the calcium sulfate crystals; wherein a defoamer comprising a dialkyl sulfosuccinate salt and an aliphatic alcohol and a poly(acrylic acid), or salt thereof, having a weight-average molecular weight of 300 to less than 1,000,000 grams per mole (g/mol), are added to the slurry.

A wet process phosphoric acid production method includes digesting phosphate-containing ore in a slurry comprising sulfuric acid, whereby phosphoric acid and calcium sulfate crystals are formed; and separating the phosphoric acid from the calcium sulfate crystals; wherein a defoamer comprising a dialkyl sulfosuccinate salt and an fatty acid ester, and a poly(acrylic acid), or salt thereof, having a weight-average molecular weight of 300 to less than 1,000,000 g/mol, are added to the slurry.

A composition for enhancing the separation of phosphoric acid from calcium sulfate crystals includes: a defoamer comprising a dialkyl sulfosuccinate salt and an aliphatic alcohol; and a poly(acrylic acid), or salt thereof, having a weight-average molecular weight of 300 to less than 1,000,000 g/mol.

A composition for enhancing the separation of phosphoric acid from calcium sulfate crystals includes: a defoamer comprising a dialkyl sulfosuccinate salt and a fatty acid ester; and a poly(acrylic acid), or salt thereof, having a weight-average molecular weight of 300 to less than 1,000,000 g/mol.

This brief description may not list all necessary characteristics or elements. Therefore subcombinations of these characteristics or elements may also constitute an invention. These and other objects, features and advantages of this invention will become apparent from the following detailed description of the various aspects of the invention taken in conjunction with the accompanying Examples and Drawings.

### BRIEF DESCRIPTION OF THE DRAWINGS

Referring now to the Drawings:

FIG. 1 depicts plots of cumulative particle size distributions of the filter cakes from the digestion of phosphate ore in Ex. 1-4, obtained using a FlowCam. ESD in the x-axis is “Equivalent Spherical Diameter”. The plots show an increase in particle size upon addition of P(AA-co-MA) (M_{w}=3000 g/mol) without defoamers during digestion. The increase in particle size depends on dosage and an optimal dosage of 0.6 kg/T P₂O₅ is observed (Ex. 3).

FIG. 2 depicts plots of cumulative particle size distributions of filter cakes from the digestion of phosphate ore in Ex. 5-8, obtained using a FlowCam. ESD in the x-axis is “Equivalent Spherical Diameter”.

FIG. 3 depicts plots of cumulative particle size distributions of filter cakes from the digestion of phosphate ore in Ex. 12-15, obtained using a FlowCam. ESD in the x-axis is “Equivalent Spherical Diameter”. The plots show the effect of molecular weight of PAA polymers in combination with IONQUEST™ D3001 defoamers during digestion of phosphate ore. While low molecular weight polymers promote crystal growth (Ex. 13-14 vs. Ex. 12), high molecular weight polymers depress crystal growth (Ex. 15 vs. Ex. 12).

FIG. 4 depicts plots of particle size distributions of filter cakes from the digestion of phosphate ore in Ex. 5, 6, and 8, obtained using a FlowCam. ESD in the x-axis is “Equivalent Spherical Diameter”. The plots show that particle size distribution shifts upwards upon addition of P(AA-co-MA) (M_{w}=3000 g/mol) and IONQUEST™ D3001 (FIG. 8), compared to no additive (Ex. 5), and IONQUEST™ D3001 alone (Ex. 6) during digestion of phosphate ore.

FIG. 5 depicts visible micrographs collected with FlowCam on filter cake crystals after digestion of phosphate ore. These images show that P(AA-co-MA) (M_{w}=3000 g/mol) in combination with IONQUEST™ D3001 (Ex. 8), promotes generation of crystal clusters/aggregates compared to IONQUEST™ D3001 alone (Ex. 6).

FIG. 6 depicts photographs of foam levels of slurries after digestion of phosphate ore in Ex. 5-7, with Ex. 6 being dosed with 8 kg/T P₂O₅ IONQUEST™ D3001 and Ex. 7 being dosed with 7.2 kg/T P₂O₅ IONQUEST™ D3001 and 0.8 kg/T P₂O₅ P(AA-Na). While IONQUEST™ D3001 reduced the amount of foam in Ex. 6 relative to Ex. 5, co-addition of P(AA-Na) (M_{w}=1200) during the digestion step while maintaining the same total amount of additive (Ex. 7) further reduced the amount of foam.

### DETAILED DESCRIPTION OF CERTAIN EMBODIMENTS OF THE INVENTION

The present inventors have developed an improved wet process phosphoric acid production method which enhances separation of phosphoric acid from calcium sulfate crystals. The method comprises digesting phosphate-containing ore in a slurry comprising sulfuric acid, whereby phosphoric acid and calcium sulfate crystals are formed; and separating the phosphoric acid from the calcium sulfate crystals; wherein a defoamer and a poly(carboxylic acid), or salt thereof, having a weight-average molecular weight of less than 1,000,000 grams per mole (g/mol) are added to the slurry. Advantageously, adding a defoamer and a poly(carboxylic acid), or salt thereof, having a weight-average molecular weight of less than 1,000,000 g/mol, to wet process phosphoric acid slurry was found to increase volume average particle size of calcium sulfate crystals, enhance separation of phosphoric acid from calcium sulfate crystals by improving filtration rates, and to simultaneously reduce foam formation.

The defoamer and poly(carboxylic acid), or salt thereof, can be added to the wet process phosphoric acid slurry in a variety of ways. For example the defoamer and poly(carboxylic acid), or salt thereof, can be added separately to the slurry. The defoamer and poly(carboxylic) acid, or salt thereof, can also be premixed before adding to the slurry. Furthermore, in any or all embodiments, the defoamer and poly(carboxylic acid), or salt thereof, can be each independently or in combination premixed with the sulfuric acid, recycled phosphoric acid, or both the sulfuric acid and recycled phosphoric acid, before adding to the slurry. It is desirable to add the defoamer and poly(carboxylic) acid, or salt thereof, during the digestion step.

Despite teachings to the contrary in the art, the present inventors have surprisingly found that low molecular weight poly(carboxylic acids), or salt thereof, i.e., those having a weight-average molecular weight of less than 1,000,000 g/mol, are effective in increasing the volume average particle size of calcium sulfate crystals in WPA production. For example, the poly(carboxylic acid) or salt thereof, can have a weight-average molecular weight of 300 to less than 1,000,000 g/mol. Within this range, the weight-average molecular weight can be greater than or equal to 500, 700, or 1,000 g/mol and less than or equal to 900,000, 700,000, 500,000, 100,000, 50,000, or 20,000 g/mol. In any or all embodiments according to the invention, the weight-average molecular weight can be 1,000 to 100,000 g/mol. Weight-average molecular weight as reported herein can be measured, for example, by gel permeation chromatography, or other suitable methods routinely known to those skilled in the art.

The poly(carboxylic acid), or salt thereof, can be an addition polymer of carboxylic acid-functional ethylenically unsaturated monomers. The carboxylic acid-functional ethylenically unsaturated monomer can be, for example, acrylic acid, methacrylic acid, crotonic acid, itaconic acid, an itaconic acid monoester, fumaric acid, a fumaric acid monoester, maleic acid, a maleic acid monoester, or a combination comprising at least one of the foregoing carboxylic acid-functional ethylenically unsaturated monomers. The poly(carboxylic acid) can also be an addition polymer of a carboxylic acid anhydride-functional ethylenically unsaturated monomer, in which the carboxylic acid anhydride functionality can be converted to carboxylic acid functionality, for example maleic anhydride or itaconic anhydride. The carboxylic acid-functional ethylenically unsaturated monomer can be (meth)acrylic acid, i.e., acrylic acid, methacrylic acid, or a combination thereof. The poly(carboxylic acid) can be in the form of an acid, a mixed acid and salt, or a salt. Any organic or inorganic cation can be used as the salt, but inorganic counterions are preferred, for example an alkali metal or an alkaline earth metal. Thus in any or all embodiments, the poly(carboxylic acid), or salt thereof, is derived from polymerization of (meth)acrylic acid, maleic acid, a (meth)acrylate salt, a maleate salt, or a combination comprising at least one of the foregoing monomers. The poly(carboxylic acid), or salt thereof, can be, for example, poly(acrylic acid), poly(acrylic acid) sodium salt, poly(acrylic acid-co-maleic acid), poly(acrylic acid-co-maleic acid) sodium salt, or a combination comprising at least one of the foregoing poly(carboxylic acids). In any or all embodiments, the poly(carboxylic acid), or salt thereof, is poly(acrylic acid), a salt thereof, for example a sodium salt thereof, or a combination comprising at least one of the foregoing. The poly(carboxylic acid), or salt thereof, can also be a copolymer of acrylic acid and maleic acid, a salt thereof, for example a sodium salt thereof, or a combination comprising at least one of the foregoing. The poly(carboxylic acid), or salt thereof, can also be a copolymer of acrylic acid and a polyethylene glycol ether methacrylate, a salt thereof, or a combination comprising at least one of the foregoing.

The poly(carboxylic acid), or salt thereof, can be a copolymer of carboxylic acid-functional ethylenically unsaturated monomer and other ethylenically unsaturated monomers. The other ethylenically unsaturated monomer can be an ionic monomer, for example, a sulfonic acid-functional monomer, a phosphoric acid-functional monomer, a phosphonic acid-functional monomer, or a salt thereof. Examples of sulfonic-acid functional monomers include 2-sulfoethyl (meth)acrylate, 3-sulfopropyl (meth)acrylate, styrene sulfonic acid, vinyl sulfonic acid, and 2-(meth)acrylamide-2-methyl propanesulfonic acid. Examples of phosphoric acid-functional monomers include 2-phosphoethyl (meth)acrylate, 2-phosphopropyl (meth)acrylate, 3-phosphopropyl (meth)acrylate, phosphobutyl (meth)acrylate, and 3-phospho-2-hydroxypropyl (meth)acrylate. The phosphoric acid-functional monomer can also be a phosphoric acid ester of an alkoxylated hydroxyalkyl (meth)acrylate, for example a hydroxyethyl or hydroxypropyl (meth)acrylate ethoxylate or propoxylate having 1 to 50 ethoxy or propoxy repeat units. The ionic monomer can also be 2-(N,N-dimethylamino)ethyl (meth)acrylate.

The other ethylenically unsaturated monomer can be a nonionic monomer. The nonionic monomer can be a hydrophilic non-ionic ethylenically unsaturated monomer, for example hydroxyethyl (meth)acrylate, hydroxypropyl (meth)acrylate, polyethylene glycol (meth)acrylate, or (meth)acrylamide. The nonionic monomer can also be a hydrophobic non-ionic monomer, for example an alkyl ester of (meth)acrylic acid, such as methyl (meth)acrylate, ethyl (meth)acrylate, butyl (meth)acrylate, 2-ethylhexyl (meth)acrylate, decyl (meth)acrylate, isodecyl (meth)acrylate, and lauryl (meth)acrylate. The nonionic monomer can also be styrene, or a substituted styrene such as α-methyl styrene, an α-olefin such as ethylene, propylene, 1-decene, and diisobutylene, or butadiene. The nonionic monomer can also be a vinyl monomer such as acrylonitrile, vinyl chloride, vinyl acetate, vinyl butyrate, or a vinyl ester of a branched, tertiary-alkyl alcohol, sold under the tradename VeoVa™, for example VeoVa™ 9 Monomer, VeoVa™ 10 Monomer, VeoVa™ 11 Monomer, available from Momentive Specialty Chemicals. In any or all embodiments according to the invention, the poly(carboxylic acid), or salt thereof, can be derived from copolymerization of (meth)acrylic acid with at least one other nonionic (meth)acrylic or vinyl monomer. For example, the poly(carboxylic acid), or salt thereof, can be a copolymer of acrylic acid and a polyethylene glycol ether methacrylate, a salt thereof, or a combination comprising at least one of the foregoing. For example, the polycarboxylic acid, or salt thereof, can be a copolymer of acrylic acid and polyethylene glycol methyl ether methacrylate with 50 ethylene glycol (EO) (MH50), (P(AA-co-MH50)). The AA to MH50 molar ratio can be, for example, 80:20.

Advantageously, a defoamer is combined with the poly(carboxylic acid), or salt thereof, to control foam in the wet process phosphoric acid process. Controlling foam can be accomplished by either decreasing an amount of foam formed or by preventing foam formation in the first place. Although the low molecular weight poly(carboxylic acids), or salts thereof, disclosed herein have no defoamer activity, the combination of a defoamer and low molecular weight poly(carboxylic acids), or salts thereof, have surprisingly been found to exhibit a synergistic effect on controlling foam.

The defoamer is a fatty acid, a fatty acid salt, a fatty acid ester, a sulfonic acid, a sulfonic acid salt, an ester of a sulfonic acid or sulfonic acid salt, an aliphatic alcohol, or a combination comprising at least one of the foregoing defoamers. As described above, the defoamer can be in the form of an acid, ester, salt, or mixed acid, ester, or salt. Any organic or inorganic cation can be used as the salt, for example an alkali metal, an alkaline earth metal, an ammonium ion, a quaternary ammonium ion, or a phosphonium ion. In any or all embodiments according to the invention, the defoamer comprises a dialkyl ester of a sulfosuccinate salt, i.e., a dialkyl sulfosuccinate. The dialkyl sulfosuccinate can have the chemical structure:

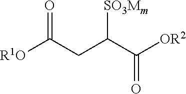

wherein R¹ and R² are each independently a linear or branched, C₄₋₁₈ alkyl, specifically C₄₋₁₂ alkyl, more specifically C₄₋₈ alkyl, C₅₋₁₈ cycloalkyl, C₇₋₁₈ arylalkyl, or C₆₋₁₈ aryl, unsubstituted or substituted by hydroxyl or C₁₋₁₈ alkoxy, more specifically C₁₋₄ alkoxy. In any or all embodiments according to the invention, M is an alkali metal, an alkaline earth metal, an ammonium ion, a quaternary ammonium ion, or a combination comprising at least one of the foregoing cations. When M is an alkaline earth metal, m is 0.5, and when M is an alkali metal or ammonium ion, m is 1. M can be, for example, lithium, sodium, potassium, calcium, or ammonium, specifically lithium, sodium, potassium, or ammonium, and more specifically, sodium. In any or all embodiments according to the invention, R¹ and R² are each independently a linear or branched C₄₋₁₂ alkyl, specifically C₄₋₈ alkyl. For example, R¹ and R² can each independently be amyl, hexyl, octyl, nonyl, dodecyl, or stearyl. Since these alkyl groups can be branched, octyl can be 2-ethylhexyl. Thus in any or all embodiments according to the invention, R¹ and R² are both 2-ethylhexyl, M is sodium, and m is 1. This specific dialkyl sulfosuccinate is known as “sodium dioctyl sulfosuccinate”.

As mentioned above, combinations of defoamers can also be effective. Thus in any or all embodiments according to the invention, a defoamer comprising a dialkyl sulfonate salt can further comprise an aliphatic alcohol, for example 2-ethylhexanol. In any or all embodiments according to the invention, the defoamer comprising a dialkyl sulfonate salt can also further comprise a fatty acid, a fatty acid salt, a fatty acid ester, or a combination thereof, for example oleic acid, an oleic acid salt, an oleic ester, or a combination thereof.

Advantageously, the low molecular weight poly(carboxylic acid), or salt thereof, provides increased volume average particle size of the calcium sulfate crystals in WPA production. Thus, a wet process phosphoric acid production method comprises digesting phosphate-containing ore in a slurry comprising sulfuric acid, and adding a sufficient amount of the poly(carboxylic acid), or salt thereof, to the slurry to increase volume average particle size of the calcium sulfate crystals compared to the same method without addition of the poly(carboxylic acid), or salt thereof.

Advantageously, the increased volume average particle size of the calcium sulfate crystals obtained in the process results in enhanced separation of phosphoric acid from the calcium sulfate crystals, for example by increasing filtration rate of the phosphoric acid. Thus, a wet process phosphoric acid production method comprises digesting phosphate-containing ore in a slurry comprising sulfuric acid, and adding a sufficient amount of the poly(carboxylic acid), or salt thereof, to the slurry to enhance separation of the phosphoric acid from the calcium sulfate crystals compared to the same method without addition of the poly(carboxylic acid), or salt thereof.

Advantageously, the combination of defoamer and low molecular weight poly(carboxylic acid), or salt thereof, also provides reduced foam formation. Thus, a wet process phosphoric acid production method comprises digesting phosphate-containing ore in a slurry comprising sulfuric acid, and adding sufficient amounts of the defoamer and the poly(carboxylic acid), or salt thereof, to reduce foam formation compared to the same method without addition of the defoamer and the poly(carboxylic acid), or salt thereof.

Many factors, including ore type, temperature, agitation, reactor design, acid chemistry, foreign ions, organic species, and viscosity of the phosphoric acid medium can affect the performance of the poly(carboxylic acid), or salt thereof. Therefore a suitable dosage of poly(carboxylic acid), or salt thereof, may depend on any of these variables, but can be determined by no more than routine methods known to those skilled in the art. Dosage is herein expressed in units of kilogram of additive per ton of P₂O₅ in the phosphate ore, and is abbreviated as “kg/T P₂O₅”. The sufficient amount of the poly(carboxylic acid), or salt thereof, to increase volume average particle size of the calcium sulfate crystals, and to thereby enhance separation of the phosphoric acid from the calcium sulfate crystals, can be in the range of 0.01 to 10 kg/T P₂O₅. Within this range, the sufficient amount of poly(carboxylic acid), or salt thereof, can be greater than or equal to 0.02, 0.05, or 0.1 kg/T P₂O₅ and less than or equal to 5, 4, 3, 2, or 1 kg/T P₂O₅.

The same factors, including ore type, temperature, agitation, reactor design, acid chemistry, foreign ions, organic species, and viscosity of the phosphoric acid medium can also affect the performance of the combination of defoamer and poly(carboxylic acid), or salt thereof in reducing foam formation. However, the sufficient amount of defoamer to reduce foam formation can be in the range of 0.1 to 20 kg/T P₂O₅. Within this range, the sufficient amount of defoamer can be greater than or equal to 0.2, 0.3, 0.4, or 0.5 kg/T P₂O₅ and less than or equal to 15, 10, 9, 8, 7, or 6 kg/T P₂O₅. Moreover, the sufficient amount of poly(carboxylic acid), or salt thereof, in combination with the defoamer, to reduce foam formation can be the same amount sufficient to increase volume average particle size and to enhance separation of the phosphoric acid from the calcium sulfate crystals disclosed in the preceding paragraph.

While not intending to limit the scope of the wet process phosphoric acid production method, more specific methods are disclosed herein. For example, a wet process phosphoric acid production method can comprise digesting phosphate-containing ore in a slurry comprising sulfuric acid, whereby phosphoric acid and calcium sulfate crystals are formed; and separating the phosphoric acid from the calcium sulfate crystals; wherein a defoamer comprising a dialkyl sulfosuccinate salt and an aliphatic alcohol and a poly(acrylic acid), or salt thereof, having a weight-average molecular weight of 300 to less than 1,000,000 g/mol, are added to the slurry. In another example of the method, a defoamer comprising a dialkyl sulfosuccinate salt and a fatty acid ester, and a poly(acrylic acid), or salt thereof, having a weight-average molecular weight of 300 to less than 1,000,000 g/mol, are added to the slurry.

As described above, the defoamer and poly(carboxylic) acid can be premixed before adding to the slurry. Thus, in any or all embodiments, a composition comprises a defoamer and a poly(carboxylic acid), or salt thereof, having a weight-average molecular weight of less than 1,000,000 g/mol. For example, a composition for enhancing the separation of phosphoric acid from calcium sulfate crystals, comprises a defoamer comprising a dialkyl sulfosuccinate salt and an aliphatic alcohol; and a poly(acrylic acid), or salt thereof, having a weight-average molecular weight of 300 to less than 1,000,000 g/mol. A composition for enhancing the separation of phosphoric acid from calcium sulfate crystals, can also comprise a defoamer comprising a dialkyl sulfosuccinate salt and a fatty acid ester; and a poly(acrylic acid), or salt thereof, having a weight-average molecular weight of 300 to less than 1,000,000 g/mol.

This disclosure is further illustrated by the following aspects, which are not intended to limit the claims.

Aspect 1. A wet process phosphoric acid production method comprising: digesting phosphate-containing ore in a slurry comprising sulfuric acid, whereby phosphoric acid and calcium sulfate crystals are formed; and separating the phosphoric acid from the calcium sulfate crystals; wherein a defoamer and a poly(carboxylic acid), or salt thereof, having a weight-average molecular weight of less than 1,000,000 g/mol, are added to the slurry.

Aspect 2. The method of aspect 1, wherein the defoamer and poly(carboxylic acid), or salt thereof, are added separately to the slurry.

Aspect 3. The method of aspect 1, wherein the defoamer and poly(carboxylic) acid, or salt thereof, are premixed before adding to the slurry.

Aspect 4. The method of aspect 3, wherein the defoamer and poly(carboxylic acid), or salt thereof, are each independently premixed with the sulfuric acid, recycled phosphoric acid, or both the sulfuric acid and recycled phosphoric acid, before adding to the slurry.

Aspect 5. The method of any of aspects 1 to 4, wherein the poly(carboxylic acid) or salt thereof, has a weight-average molecular weight of 300 to less than 1,000,000 g/mol.

Aspect 6. The method of any of aspects 1 to 5, wherein the poly(carboxylic acid), or salt thereof, is derived from polymerization of (meth)acrylic acid, maleic acid, a (meth)acrylate salt, a maleate salt, or a combination comprising at least one of the foregoing monomers.

Aspect 7. The method of any of aspects 1 to 6, wherein the poly(carboxylic acid), or salt thereof, is poly(acrylic acid), a salt thereof, or a combination comprising at least one of the foregoing.

Aspect 8. The method of any of aspects 1 to 6, wherein the poly(carboxylic acid), or salt thereof, is a copolymer of acrylic acid and maleic acid, a salt thereof, or a combination comprising at least one of the foregoing.

Aspect 9. The method of any of aspects 1 to 6, wherein the poly(carboxylic acid), or salt thereof, is a copolymer of acrylic acid and a polyethylene glycol ether methacrylate, a salt thereof, or a combination comprising at least one of the foregoing.

Aspect 10. The method of any of aspects 1 to 9, wherein the defoamer comprises a fatty acid, a fatty acid salt, a fatty acid ester, a sulfonic acid, a sulfonic acid salt, a sulfonic acid ester, an aliphatic alcohol, or a combination comprising at least one of the foregoing defoamers.

Aspect 11. The method of any of aspects 1 to 10, wherein the defoamer comprises a dialkyl sulfosuccinate salt.

Aspect 12. The method of aspect 11, wherein the dialkyl sulfosuccinate salt has the chemical structure:

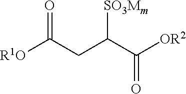

wherein R¹ and R² are each independently a linear or branched C₄₋₁₈ alkyl, C₅₋₁₈ cycloalkyl, C₇₋₁₈ arylalkyl, or C₆₋₁₈ aryl, unsubstituted or substituted by hydroxyl or C₁₋₁₈ alkoxy; M is lithium, sodium, potassium, or ammonium; and m is 1.

Aspect 13. The method of aspect 12, wherein R¹ and R² are both 2-ethylhexyl, and M is sodium.

Aspect 14. The method of any of aspects 11 to 13, wherein the defoamer further comprises an aliphatic alcohol.

Aspect 15. The method of aspect 14, wherein said aliphatic alcohol comprises 2-ethylhexanol.

Aspect 16. The method of any of aspects 11 to 13, wherein the defoamer further comprises a fatty acid, a fatty acid salt, a fatty acid ester, or a combination comprising at least one of the foregoing defoamers.

Aspect 17. The method of any of aspects 11 to 13, wherein the defoamer further comprises a tall oil fatty acid, a tall oil fatty acid salt, an oleic acid, an oleic acid salt, or a combination comprising at least one of the foregoing defoamers.

Aspect 18. The method of any of aspects 1 to 17, wherein each salt is independently a lithium salt, a sodium salt, a potassium salt, an ammonium salt, or a combination comprising at least one of the foregoing salts.

Aspect 19. The method of any of aspects 1 to 18, wherein a sufficient amount of the poly(carboxylic acid), or salt thereof, is added to the slurry to increase volume average particle size of the calcium sulfate crystals compared to the same method without addition of the poly(carboxylic acid), or salt thereof.

Aspect 20. The method of any of aspects 1 to 19, wherein a sufficient amount of the poly(carboxylic acid), or salt thereof, is added to the slurry to enhance separation of the phosphoric acid from the calcium sulfate crystals compared to the same method without addition of the poly(carboxylic acid), or salt thereof.

Aspect 21. The method of any of aspects 1 to 20, wherein sufficient amounts of the defoamer and the poly(carboxylic acid), or salt thereof, are added to the slurry to reduce foam formation compared to the same method without addition of the defoamer and the poly(carboxylic acid), or salt thereof.

Aspect 22. The method of any of aspects 19 to 21, wherein the sufficient amount of poly(carboxylic acid), or salt thereof, is 0.01 to 10 kg/T P₂O₅.

Aspect 23. The method of aspect 21, wherein the sufficient amount of poly(carboxylic acid), or salt thereof, is 0.01 to 10 kg/T P₂O₅, and the sufficient amount of defoamer is 0.1 to 20 kg/T P₂O₅.

Aspect 24. A wet process phosphoric acid production method comprising: digesting phosphate-containing ore in a slurry comprising sulfuric acid, whereby phosphoric acid and calcium sulfate crystals are formed; and separating the phosphoric acid from the calcium sulfate crystals; wherein a defoamer comprising a dialkyl sulfosuccinate salt and an aliphatic alcohol, and a poly(acrylic acid), or salt thereof, having a weight-average molecular weight of 300 to less than 1,000,000 g/mol, are added to the slurry.

Aspect 25. A wet process phosphoric acid production method comprising: digesting phosphate-containing ore in a slurry comprising sulfuric acid, whereby phosphoric acid and calcium sulfate crystals are formed; and separating the phosphoric acid from the calcium sulfate crystals; wherein a defoamer comprising a dialkyl sulfosuccinate salt and a fatty acid ester, and a poly(acrylic acid), or salt thereof, having a weight-average molecular weight of 300 to less than 1,000,000 g/mol, are added to the slurry.

Aspect 26. A composition for enhancing the separation of phosphoric acid from calcium sulfate crystals, the composition comprising: a defoamer and a poly(carboxylic acid), or salt thereof, having a weight-average molecular weight of less than 1,000,000 g/mol.

Aspect 27. A composition for enhancing the separation of phosphoric acid from calcium sulfate crystals, the composition comprising: a defoamer comprising a dialkyl sulfosuccinate salt and an aliphatic alcohol; and a poly(acrylic acid), or salt thereof, having a weight-average molecular weight of 300 to less than 1,000,000 g/mol.

Aspect 28. A composition for enhancing the separation of phosphoric acid from calcium sulfate crystals, the composition comprising: a defoamer comprising a dialkyl sulfosuccinate salt and a fatty acid ester; and a poly(acrylic acid), or salt thereof, having a weight-average molecular weight of 300 to less than 1,000,000 g/mol.

### EXAMPLES

The following examples are provided to assist one skilled in the art to further understand certain embodiments of the present invention. These examples are intended for illustration purposes and should not be construed as limiting the scope of the present invention.

The performance of low molecular weight poly(carboxylic acid) homo- or co-polymers and their salts, applied by themselves or in combination with conventional defoamers, for increasing the average particle sizes of gypsum crystals, controlling the foam, and enhancing the filtration rate of phosphoric acid slurry is measured via bench-scale digestion and a vacuum filtration test. The general procedures are outlined below. Those skilled in the art will appreciate that different volumes, ratios, and addition rates may be used to generate different phosphoric acid slurries.

### General Procedure for Bench-scale Digestion of Phosphate Ores

A 500-mL jacketed reactor connected with a thermal bath for keeping temperature at around 80° C. was used for digestion of phosphate ore in powder form. The reactor was also connected to a cooling condenser to avoid water evaporation during the digestion. Phosphoric acid and sulfuric acid were added to the reactor continuously through two peristaltic pumps (MasterFlex L/S). The phosphate ore powder was manually added roughly continuously at a corresponding rate. In one embodiment, the feed rate of sulfuric acid (52.4%) was 3.67 g/minute; the feed rate of phosphoric acid (37.1%) was 7.67 g/minute; and the feed rate of phosphate ore was 2 g/minute. The total feed time was around 30 minutes. After feeding acids and ore, the digestion was continued for an additional 2 to 3 hours to fully digest the ore. When reagents of interest (such as poly(carboxylic acid), or salts thereof, and defoamers) were used, appropriate amount of reagents were first mixed with the aforementioned phosphoric acid feed and then pumped into the reactor continuously. The reagents alternatively could have been added directly into slurry or be first mixed with sulfuric acid, or phosphate ore powder. During the whole process, the digestion slurry was stirred with an overhead stirrer (Glas-Col Precision Speed Controlled Stirrer) equipped with a propeller-type impeller running at 300 rpm.

### Filtration Test for Phosphoric Acid Slurries

210 g of phosphoric acid slurry after digestion was transferred to a filtration funnel with a 45-μm polypropylene net filter (Millipore PP4504700) and vacuum filtration was started immediately. Filtration time reported herein is the time when the surface of the filter cake was free of phosphoric acid.

### Method for Analysis of Particle Sizes in Filter Cake

Volume average particle size and volume average particle size distribution of the filter cake were determined using FlowCam, a dynamic imaging particle analysis instrument. In this analysis, 1 to 2 mg of dried filter cake particles were first dispersed in 6 mL of propylene glycol. An appropriate amount of the particle dispersion was then transferred to a pipet tip reservoir connected to a flow cell (FC300) supported on a cell holder. The dynamic imaging process was started afterwards and images of tens of thousands of particles were taken. At the end, these images were analyzed with the FlowCam software, generating results such as volume average particle size, volume average particle size distribution, aspect ratio, and aspect ratio distribution.

### Examples 1-25. Digestion of Phosphate Ore a with or without Crystal Growth Modifiers

Poly(acrylic acid) polymers (PAA), poly(acrylic acid-co-maleic acid) polymers (P(AA-co-MA)), and their salts (such as sodium polyacrylate (P(AA-Na)) of various molecular weights were purchased from Sigma-Aldrich, St. Louis, Mo., or Polyscience, Inc., Warrington, Pa. A copolymer of acrylic acid (AA) and polyethylene glycol methyl ether methacrylate (with 50 EO, MH50), with an AA to MH50 molar ratio of 80:20 (P(AA-co-MH50) was obtained from Solvay S.A. The weight-average molecular weights herein are those reported by the above vendors. The method of measuring the reported weight-average molecular weights is not provided by the vendors. However, weight-average molecular weight can be measured, for example, by gel permeation chromatography.

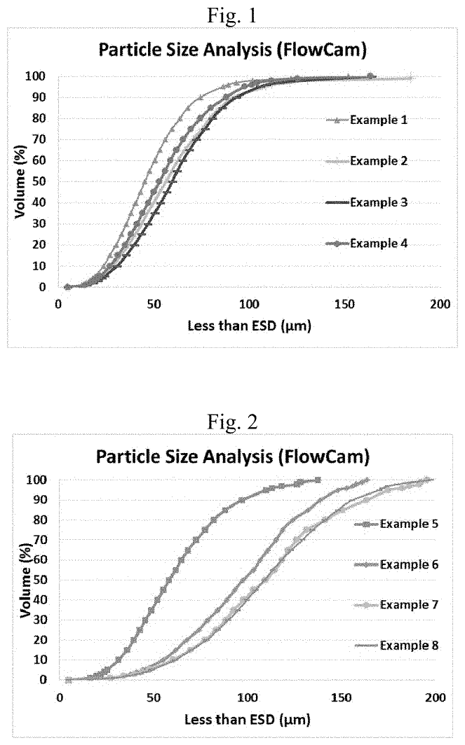

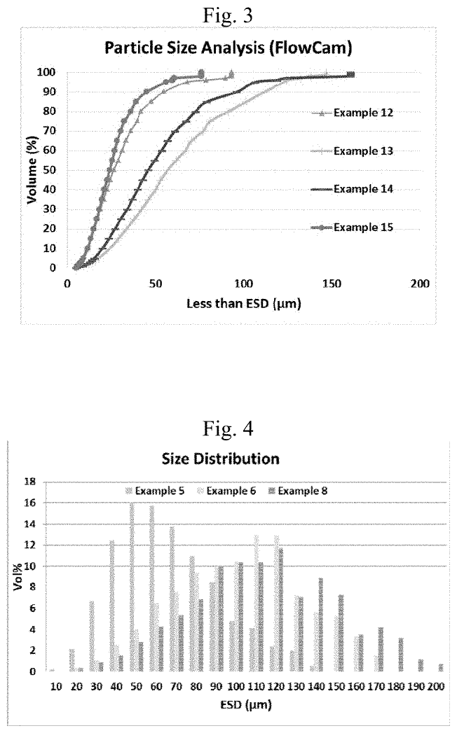

Defoamers CYBREAK™ 675HFP (mixture of sulfosuccinate surfactants and aliphatic alcohols) and IONQUEST™ D3001 (alkali salt of sulfosuccinic acid dialkyl esters and fatty acid esters) were obtained from Solvay SA. Defoamer #3 was a mixture of sodium dioctyl sulfosuccinate (70% in propylene glycol), fatty acid esters, a glycol ether, and 2-ethylhexanol in a 4:4:1:1 ratio. Defoamer #4 was a mixture of oleic acid and 2-ethylhexanol in a 9:1 weight ratio. The efficacy of these polymers, by themselves and in combination with defoamers, in promoting crystal growth and enhancing filtration rate was studied using the aforementioned digestion procedure, filtration test, and particle size analysis method. Results from digestion of phosphate ores from various sources are shown in Table 1-5. Each table represents a different set of tests. Ex. 1, 5, 12, 16, 21, and 26 were controls without any defoamer or poly(carboxylic acid), or salt thereof. Cumulative particle size distributions of the filter cakes Ex. 1-4, 5-8, and 12-15 are provided in FIGS. 1, 2, and 3, respectively. Particle size distribution of the filter cakes of Ex. 5, 6, and 8 are provided in FIG. 4.

TABLE 1
Dosage Effect of P(AA-co-MA) on Particle Size and Filtration Rate
Without Defoamer

| | | | | | | Vol. Ave. |
|---|---|---|---|---|---|---|
| | Phosphate | | Dosage | | Filtration | Particle Size |
| Ex. | Ore Type | Reagents | (kg/T P₂O₅) | Defoamer | Time (s) | (μm) |
| 1^{a} | A | None | — | None | 89 | 45.4 |
| 2 | A | P(AA-co-MA) | 0.3 | None | 69 | 56.4 |
| | | (M_{w} = 3000) | | | | |
| 3 | A | P(AA-co-MA) | 0.6 | None | 50 | 59.7 |
| | | (M_{w} = 3000) | | | | |
| 4 | A | P(AA-co-MA) | 1.2 | None | 62 | 52.9 |
| | | (M_{w} = 3000) | | | | |

^{a}Comparative Example.

TABLE 2
Dosage and Molecular Weight Effects of PAA, P(AA-Na), and P(AA-MA)
On Particle Size and Filtration Rate with IONQUEST ™ D3001 Defoamer

| | | | | | | | Vol. Av. |
|---|---|---|---|---|---|---|---|
| | | | Dosage | | Dosage | Filtration | Particle |
| | Phosphate | | (kg/T | | (kg/T | Time | Size |
| Ex. | Ore Type | Reagent | P₂O₅) | Defoamer | P₂O₅) | (s) | (μm) |
| 5^{a} | B | None | — | None | — | 20 | 58.5 |
| 6^{a} | B | None | — | IONQUEST ™ | 8 | 20 | 97.4 |
| | | | | D3001 | | | |
| 7 | B | P(AA-Na) | 0.8 | IONQUEST ™ | 7.2 | 14 | 109.1 |
| | | (M_{w} = 1200) | | D3001 | | | |
| 8 | B | P(AA-MA) | 0.8 | IONQUEST ™ | 7.2 | 12 | 109.0 |
| | | (M_{w} = 3000) | | D3001 | | | |
| 9 | B | PAA | 0.45 | IONQUEST ™ | 4.1 | 14 | 104.8 |
| | | (M_{w} = 100k) | | D3001 | | | |
| 10 | B | P(AA-Na) | 2 | None | — | 34 | — |
| | | (M_{w} = 1200) | | | | | |
| 11^{a,b} | B | P(AA-Na) | 0.8 | IONQUEST ™ | 7.2 | 19 | — |
| | | (M_{w} = 1200) | | D3001 | | | |

^{a}Comparative Examples.
^{b}PAA and defoamer were dosed to slurry after the digestion step and before the filtration step.

TABLE 3
Molecular Weight Effect of PAA Homo- and Co-polymers
On Particle Size and Filtration Rate with IONQUEST ™ D3001 Defoamer

| | | | Dosage | | Dosage | | Vol. Ave. |
|---|---|---|---|---|---|---|---|
| | Phosphate | | (kg/T | | (kg/T | Filtration | Particle |
| Ex. | Ore Type | Reagent | P₂O₅) | Defoamer | P₂O₅) | Time (s) | Size (μm) |
| 12^{a} | C | Blank | — | None | — | 100 | 26.4 |
| 13 | C | P(AA-co- | 0.6 | IONQUEST ™ | 6 | 20 | 55.5 |
| | | MH50) 80/20 | | D3001 | | | |
| | | (M_{w} = 15.4k) | | | | | |
| 14 | C | PAA | 0.6 | IONQUEST ™ | 6 | 18 | 47.1 |
| | | (M_{w} = 450k) | | D3001 | | | |
| 15 | C | PAA | 0.6 | IONQUEST ™ | 6 | 180 | 24.5 |
| | | (M_{w} = 1,000k) | | D3001 | | | |

^{a}Comparative Example.

TABLE 4
Dosage Effect of P(AA-Na) on Particle Size and Filtration Rate
With CYBREAK ™ 675 HFP Defoamer)

| | | | Dosage | | Dosage | | Vol. Ave. |
|---|---|---|---|---|---|---|---|
| | Phosphate | | (kg/T | | (kg/T | Filtration | Particle |
| Ex. | Ore Type | Reagents | P₂O₅) | Defoamer | P₂O₅) | Time (s) | Size (gm) |
| 16^{a} | D | None | — | None | — | 112 | 42.2 |
| 17 | D | P(AA-Na) | 0.18 | None | — | 58 | 52.8 |
| | | (M_{w} = 1200) | | | | | |
| 18^{a} | D | None | — | CYBREAK ™ | 1.2 | 99 | 38.3 |
| | | | | 675 HFP | | | |
| 19 | D | P(AA-Na) | 0.06 | CYBREAK ™ | 0.6 | 104 | 43.1 |
| | | (M_{w} = 1200) | | 675 HFP | | | |
| 20 | D | P(AA-Na) | 0.12 | CYBREAK ™ | 1.2 | 40 | 52.9 |
| | | (M_{w} = 1200) | | 675 HFP | | | |

^{a}Comparative Examples.

TABLE 5
Dosage Effect of P(AA-Na) on Filtration Rate with Defoamer #3 and Defoamer #4)

| | Phosphate | | Dosage | | Dosage | Filtration | Foam |
|---|---|---|---|---|---|---|---|
| Ex. | Ore Type | Reagents | (kg/T P₂O₅) | Defoamer | (kg/T P₂O₅) | Time (s) | Volume (mL) |
| 21^{a} | E | None | — | None | — | 80 | 40 |
| 22^{a} | E | None | — | Defoamer #3^{b} | 6.0 | 40 | 20 |
| 23 | E | PAA | 0.6 | Defoamer #3^{b} | 5.4 | 21 | 5 |
| | | (M_{w} = 100,000) | | | | | |
| 24^{a} | E | None | — | Defoamer #4^{c} | 6.0 | 30 | 10 |
| 25 | E | PAA | 0.6 | Defoamer #4^{c} | 5.4 | 22 | 5 |
| | | (M_{w} = 100,000) | | | | | |

^{a}Comparative Examples.
^{b}Defoamer #3 was Sodium dioctyl sulfosuccinate (70% in propylene glycol), fatty acid esters, glycol ether, and 2-ethyl hexanol in 4:4:1:1 ratio.
^{c}Defoamer #4 was 90% Oleic acid + 10% 2-ethylhexanol.

TABLE 6
Dosage Effect of PAA after Digestion
on Filtration Rate Without Defoamer

| | Phosphate | | Dosage | | Filtration |
|---|---|---|---|---|---|
| Ex. | Ore Type | Reagents | (kg/T P₂O₅) | Defoamer | Time (s) |
| 26^{a} | F | None | — | None | 31 |
| 27^{a,b} | F | P(AA) | 0.18 | None | 32 |

^{a}Comparative Example.
^{b}PAA was dosed to slurry after the digestion step and before the filtration step.

It is known in the art (e.g. in U.S. Pat. No. 5,009,873) that high molecular weight (M_{w}>1,000,000) is necessary for a polymer to be effective in promoting crystal growth. Low molecular weight polymers (M_{w}<1,000,000) are generally used as dispersants or antiscalants to depress crystal growth and agglomeration. Thus it was surprising that low molecular weight poly(carboxylic acid) homo- and co-polymers and their salts, alone and in combination with defoamers, can increase the particle size of crystals during digestion of phosphate ores from various sources and thereby improve filtration rate. Increase in particle size and improved filtration rate were not observed when a high molecular weight PAA (M_{w}≥1,000,000) was used. To the contrary, as shown in Comparative Ex. 15, high molecular weight PAA was detrimental to crystal growth and filtration rate. The dosage level of low molecular weight poly(carboxylic acid) polymers and salts thereof can affect particle size and filtration rate. While both a low dosage of about 0.06 to 0.3 kg/T P₂O₅ (as in Ex. 19 and 2, respectively) and a high dosage of about 1.2 kg/T P₂O₅ (as in Ex. 4) provide some improvement in particle size and filtration rate, particle size and filtration rate can be optimal between these limits. Optimal dosage can depend on the specific ore and digestion process used.

The comparisons of Ex. 7 to Ex. 11 and of Ex. 27 to Ex. 26 indicate that the poly(carboxylic acid), or salt thereof, alone or in combination with defoamers, should be dosed during the digestion step to obtain increased particle size and reduced filtration rate. If they are dosed after the digestion step, as in Ex. 11 and 27, there was no improvement in filtration rate compared to the controls (Ex. 6 and 26, respectively).

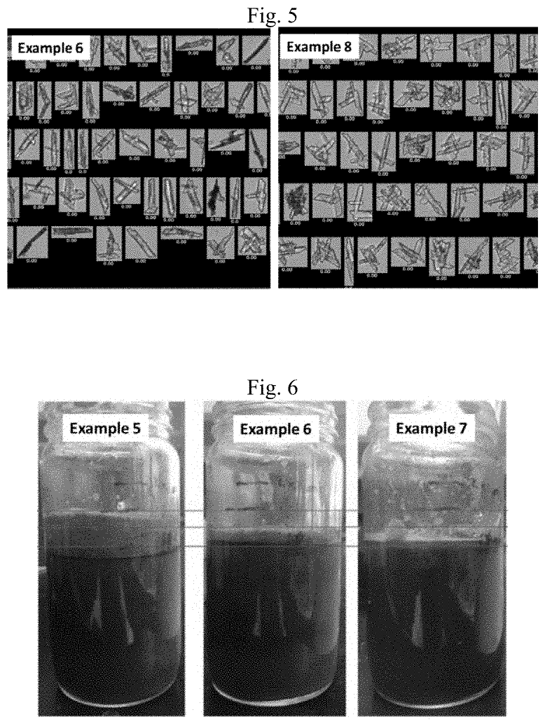

FIG. 5 depicts visible micrographs collected with FlowCam on filter cake crystals after digestion of phosphate ore. These images show that P(AA-co-MA) (M_{w}=3,000), in combination with IONQUEST™ D3001, promotes generation of crystal clusters/aggregates. These data are contrary to the expectation that low molecular weight polymers disperse particles and prevent them from forming aggregates. In addition, it is also unexpected that defoamer efficacy (e.g. CYBREAK™ 675 HFP and IONQUEST™ D3001) are also improved when co-dosed with low molecular weight poly(carboxylic acid)s or salts thereof during digestion of phosphate ores. Controlling foam can be effected by either decreasing the amount of foam or preventing the formation of foam. FIG. 6 depicts photographs of foam levels of slurries after digestion of phosphate ore in Ex. 5-7, with Ex. 6 being dosed with 8 kg/T P₂O₅ IONQUEST™ D3001, and Ex. 7 being dosed with 0.8 kg/T P₂O₅ P(AA-Na) and 7.2 kg/T P₂O₅ IONQUEST™ D3001. While IONQUEST™ D3001 reduced the amount of foam in Ex. 6 relative to Ex. 5, co-addition of P(AA-Na) (M_{w}=1200) during the digestion step (Ex. 7) further reduced the amount of foam. However, low molecular weight poly(carboxylic acid)s or salts thereof, by themselves, have no defoamer activity. Foam volumes of Ex. 21-25 are listed in Table 5. Comparison of Ex. 23 to Ex. 22 and of Ex. 25 to Ex. 24 also shows the advantageous effect of the low molecular weight poly(carboxylic acid)s or salts thereof on foaming when used in combination with a defoamer. Moreover, the combination of defoamer and low molecular weight poly(carboxylic acid) provide an unexpected synergistic effect on controlling foam. As shown in Table 5, 6.0 kg/T P₂O₅ Defoamer #3 (Ex. 22) provides 20 mL of foam, while the combination of 5.4 kg/T P₂O₅ Defoamer #3 and 0.6 kg/T P₂O₅ PAA (Ex. 23, same total amount of additives) provides 5 mL of foam. Similarly, 6.0 kg/T P₂O₅ Defoamer #4 (Ex. 24) provides 10 mL of foam, while the combination of 5.4 kg/T P₂O₅ Defoamer #4 and 0.6 kg/T P₂O₅ PAA (Ex. 25, same total amount of additives) provides 5 mL of foam. The synergistic effect of the combination of defoamer and low molecular weight poly(carboxylic acid) on foam control is unexpected.

In summary, the data in Tables 1-6 and in FIGS. 1-6 show that addition of effective amounts of a defoamer and a low molecular weight poly(carboxylic acid), or salt thereof, during the digestion of phosphate bearing ores increases volume average particle size, enhances filtration rate, and controls foam.

As used herein, the term “(meth)acrylic acid” denotes acrylic acid, methacrylic acid, or a combination of acrylic acid and methacrylic acid. The acronym “PAA” refers to polyacrylic acid in particular. Similarly, the term “(meth)acrylate” denotes acrylate, methacrylate, or a combination of acrylate and methacrylate.

A used herein a “salt” can be an alkali metal salt, an alkaline earth metal salt, an ammonium salt, or a quaternary ammonium salt. The salt can be, for example, a lithium salt, a sodium salt, a potassium salt, a calcium salt, or an ammonium salt. In any or all embodiments, the salt is a sodium salt.

As used herein, “low molecular weight” refers to a weight-average molecular weight of less than 1,000,000 grams per mole (g/mol), and “high molecular weight” refers to a weight-average molecular weight of greater than or equal to 1,000,000 g/mol. For example, the phrase, “low molecular weight poly(carboxylic acid)” refers to a poly(carboxylic acid) having a weight-average molecular weight of less than 1,000,000 g/mol.

Dosage is herein expressed in units of kilogram of additive per ton of P₂O₅ in the phosphate ore, and is abbreviated as “kg/T P₂O₅”.

The invention may be embodied in many different forms and should not be construed as limited to the embodiments set forth herein; rather, these embodiments are provided so that this disclosure will satisfy applicable legal requirements. As used herein and in the appended claims, the singular forms include plural referents unless the context clearly dictates otherwise.

Those skilled in the art will appreciate that while preferred embodiments are discussed in more detail herein, multiple embodiments of the methods and compositions described herein are contemplated as being within the scope of the present invention. Thus, it should be noted that any feature described with respect to one aspect or one embodiment of the invention is combinable or interchangeable with another aspect or embodiment of the invention unless otherwise stated. It will be understood by those skilled in the art that any description of the invention, even though described in relation to a specific embodiment or drawing, is applicable to and interchangeable with other embodiments of the present invention.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group including any two or more of the explicitly listed elements, components, or features. Additionally, the omission of any element, component, or feature recited in a list may also be considered part of the present disclosure.

Those skilled in the art will further understand that any recitation herein of a numerical range with lower and upper endpoints includes all numbers subsumed within the recited range (including fractions), whether explicitly recited or not, as well as the endpoints of the range and equivalents. Thus, “1 to 5” includes 1, 2, 3, 4, and 5 when referring to, for example, a number of elements, and can also include, for example, 1.5, 2, 2.75, and 3.8 when referring to, values of parameters. Disclosure of a narrower range or more specific group in addition to a broader range or larger group is not a disclaimer of the broader range or larger group. All ranges disclosed herein are inclusive of the endpoints, and the endpoints are independently combinable with each other. For example, ranges of “up to 25 wt. %, or, more specifically, 5 wt. % to 20 wt. %”, are inclusive of the endpoints and all intermediate values of the ranges, including “5 wt. % to 25 wt. %”, etc.

The methods and compositions herein can alternatively comprise, consist of, or consist essentially of, any appropriate steps or components separately disclosed herein. The methods and compositions can additionally, or alternatively, be formulated so as to be devoid, or substantially free, of any steps or materials that are otherwise not necessary to the achievement of the function or objectives of the methods and compositions.

“Combinations” is inclusive of blends, mixtures, alloys, reaction products, and the like. “Or” means “and/or” unless clearly stated otherwise. “A and/or B” means “A, B, or a combination of A and B”.

Unless specified to the contrary herein, all test standards are the most recent standard in effect as of the filing date of this application, or, if priority is claimed, the filing date of the priority application.

Unless defined otherwise herein, technical and scientific terms used herein have the same meaning as is commonly understood by one of skill in the art to which this application belongs.

All cited patents, patent applications, and other references are incorporated herein by reference in their entirety. However, if a term in the present disclosure contradicts or conflicts with a term in the incorporated reference, the term from the present disclosure takes precedence over the conflicting term from the incorporated reference.

What is claimed is:

1. A wet process phosphoric acid production method comprising:
digesting phosphate-containing ore in a slurry comprising sulfuric acid, whereby phosphoric acid and calcium sulfate crystals are formed; and
separating the phosphoric acid from the calcium sulfate crystals;
wherein a defoamer and a poly(carboxylic acid), or salt thereof, having a weight-average molecular weight of less than 1,000,000 grams per mole (g/mol), are added to the slurry.

2. The method of claim 1, wherein the defoamer and poly(carboxylic acid), or salt thereof, are added separately to the slurry.

3. The method of claim 1, wherein the defoamer and poly(carboxylic) acid, or salt thereof, are premixed before adding to the slurry.

4. The method of claim 1, wherein the defoamer and poly(carboxylic acid), or salt thereof, are each independently premixed with the phosphate-containing ore, the sulfuric acid, recycled phosphoric acid, or both the sulfuric acid and recycled phosphoric acid, before adding to the slurry.

5. The method of claim 1, wherein the poly(carboxylic acid) or salt thereof, has a weight-average molecular weight of 300 to less than 1,000,000 g/mol.

6. The method of claim 1, wherein the poly(carboxylic acid), or salt thereof, is derived from polymerization of (meth)acrylic acid, maleic acid, a (meth)acrylate salt, a maleate salt, or a combination comprising at least one of the foregoing monomers.

7. The method of claim 1, wherein the poly(carboxylic acid), or salt thereof, is poly(acrylic acid), a salt thereof, or a combination comprising at least one of the foregoing.

8. The method of claim 1, wherein the poly(carboxylic acid), or salt thereof, is a copolymer of acrylic acid and maleic acid, a salt thereof, or a combination comprising at least one of the foregoing.

9. The method of claim 1, wherein the poly(carboxylic acid), or salt thereof, is a copolymer of acrylic acid and a polyethylene glycol ether methacrylate, a salt thereof, or a combination comprising at least one of the foregoing.

10. The method of claim 1, wherein the defoamer is a fatty acid, a fatty acid salt, a fatty acid ester, a sulfonic acid, a sulfonic acid salt, a sulfonic acid ester, an aliphatic alcohol, or a combination comprising at least one of the foregoing defoamers.

11. The method of claim 1, wherein the defoamer comprises a dialkyl sulfosuccinate salt.

12. The method of claim 11, wherein the dialkyl sulfosuccinate salt has the chemical structure: 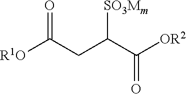
wherein R¹ and R² are each independently a linear or branched C₄₋₁₈ alkyl, C₅₋₁₈ cycloalkyl, C₇₋₁₈ arylalkyl, or C₆₋₁₈ aryl, unsubstituted or substituted by hydroxyl or C₁₋₁₈ alkoxy; M is lithium, sodium, potassium, or ammonium; and m is 1.

13. The method of claim 11, wherein the defoamer further comprises an aliphatic alcohol.

14. The method of claim 11, wherein the defoamer further comprises a fatty acid, a fatty acid salt, a fatty acid ester, or a combination comprising at least one of the foregoing defoamers.

15. The method of claim 1, wherein a sufficient amount of the poly(carboxylic acid), or salt thereof, is added to the slurry to increase volume average particle size of the calcium sulfate crystals compared to the same method without addition of the poly(carboxylic acid), or salt thereof.

16. The method of claim 1, wherein a sufficient amount of the poly(carboxylic acid), or salt thereof, is added to the slurry to enhance separation of the phosphoric acid from the calcium sulfate crystals compared to the same method without addition of the poly(carboxylic acid), or salt thereof.

17. The method of claim 1, wherein sufficient amounts of the defoamer and the poly(carboxylic acid), or salt thereof, are added to the slurry to reduce foam formation compared to the same method without addition of the defoamer and the poly(carboxylic acid), or salt thereof.

18. The method of claim 15, wherein the sufficient amount of poly(carboxylic acid), or salt thereof, is 0.01 to 10 kg/T P₂O₅.

19. The method of claim 17, wherein the sufficient amount of poly(carboxylic acid), or salt thereof, is 0.01 to 10 kg/T P₂O₅, and the sufficient amount of defoamer is 0.1 to 20 kg/T P₂O₅.

20. A wet process phosphoric acid production method comprising:
digesting phosphate-containing ore in a slurry comprising sulfuric acid, whereby phosphoric acid and calcium sulfate crystals are formed; and
separating the phosphoric acid from the calcium sulfate crystals;
wherein a defoamer comprising a dialkyl sulfosuccinate salt and an aliphatic alcohol, and a poly(acrylic acid), or salt thereof, having a weight-average molecular weight of 300 to less than 1,000,000 g/mol, are added to the slurry.

21. A wet process phosphoric acid production method comprising:
digesting phosphate-containing ore in a slurry comprising sulfuric acid, whereby phosphoric acid and calcium sulfate crystals are formed; and
separating the phosphoric acid from the calcium sulfate crystals;
wherein a defoamer comprising a dialkyl sulfosuccinate salt and a fatty acid ester, and a poly(acrylic acid), or salt thereof, having a weight-average molecular weight of 300 to less than 1,000,000 g/mol, are added to the slurry.

22. A composition for enhancing the separation of phosphoric acid from calcium sulfate crystals, the composition comprising:
a defoamer comprising a dialkyl sulfosuccinate salt and an aliphatic alcohol; and
a poly(acrylic acid), or salt thereof, having a weight-average molecular weight of 300 to less than 1,000,000 g/mol.

23. A composition for enhancing the separation of phosphoric acid from calcium sulfate crystals, the composition comprising:
a defoamer comprising a dialkyl sulfosuccinate salt and a fatty acid ester; and
a poly(acrylic acid), or salt thereof, having a weight-average molecular weight of 300 to less than 1,000,000 g/mol.
